(19) United States
(12) Patent Application Publication
(10) Pub. No.: US 2010/0267425 A1
(43) Pub. Date: Oct. 21, 2010

(54) HANDS-FREE ENFORCING APPARATUS

(76) Inventor: Moshe Nakash, Bat Yam (IL)

Correspondence Address: DANIEL J SWIRSKY, 55 REUVEN ST., BEIT SHEMESH, 99544, IL

(21) Appl. No.: 12/744,328

(22) PCT Filed: Nov. 9, 2008
(86) PCT No.: PCT/IL08/01476

§ 371 Date: May 24, 2010

(30) Foreign Application Priority Data
Nov. 22, 2007 (IL) 187558

(51) Int. Cl. H04M 1/00

(52) U.S. Cl. 455/569.1

(57) ABSTRACT

In one embodiment, the present invention is directed to a hands-free enforcing apparatus, comprising: a hands-free adapter; and a switching mechanism for sensing presence/absence of a cellular telephone in the hands-free adapter, and affecting a circuit of the vehicle thereof according to the sensed state. The apparatus may further comprise a delaying circuitry, for delaying the operation of affecting the circuit, thereby enabling a user thereof to return the cellular phone into the hands-free adapter before interfering in the operation of the circuit, and a buzzer, for alerting the user upon delaying the affecting. The circuit affected by the switching mechanism may be related to the ignition of the vehicle, to controlling the hazard signal of the vehicle, and so forth.

### FIELD OF THE INVENTION

The present invention relates to the field of cellular telephone accessories. More particularly, the invention relates to an apparatus for enforcing a user to use a stationary hands-free adapter while driving.

### BACKGROUND OF THE INVENTION

Drivers who are using cellular phones may become distracted by the act of dialing, a conversation they are having, presence of a cellular phone in their hand while they attempt to turn corners, or engage in sudden driving maneuvers, and so forth. In the past there have been numerous cases where a driver, talking on a cellular phone, drove directly into the back of a stopped vehicle.

One of the devices that may reduce the probability of car accident while using a cellular phone during driving is the hands-free adapter.

There is a common believe that using a hands-free adapter while driving is safer than using a handheld phone, and some states even have forbidden the use of cellular phones while driving, unless the driver employs a hands-free adapter for this purpose. Nevertheless, from the technical point of view the decision as to whether to use the hands-free adapter is up to the user, and there is no technical way to enforce him to use it.

It is an object of the present invention to provide an apparatus for enforcing a cellular phone user to use a hands-free adapter while driving.

Other objects and advantages of the invention will become apparent as the description proceeds.

### SUMMARY OF THE INVENTION

The following embodiments and aspects thereof are described and illustrated in conjunction with systems, tools and methods, which are meant to be merely illustrative, not limiting in scope. In various embodiments, one or more of the above-described problems have been reduced or eliminated, while other embodiments are directed to other advantages or improvements.

The term “switching mechanism” refers herein to a sensor which detects at least two states, such as on/off, close/open, etc. The switching mechanism may further comprise additional circuitry, which performs some activity according to the detected state.

In one embodiment, the present invention is directed to a hands-free enforcing apparatus, comprising:
a hands-free adapter; and
a switching mechanism for sensing presence/absence of a cellular telephone in the hands-free adapter, and affecting a circuit of the vehicle thereof according to the sensed state.

According to one embodiment of the invention, the circuit closes upon presence of a cellular telephone in the hands-free adapter, and opened upon absence of a cellular telephone in the hands-free adapter.

According to another embodiment of the invention, the circuit opens upon presence of a cellular telephone in the hands-free adapter, and closed upon absence of a cellular telephone in the hands-free adapter.

The apparatus may further comprise a delaying circuitry, for delaying the operation of affecting the circuit, thereby enabling a user thereof to return the cellular phone into the hands-free adapter.

The apparatus may further comprise a buzzer, for alerting the user, e.g., upon delaying the affecting, upon affecting the circuit, and so on. The loudness of the buzzer may be such that a user will not be able to perform a telephone conversation.

The circuit affected by the switching mechanism may be related to ignition of the vehicle, to controlling the hazard signal of the vehicle, and so forth.

According to a further embodiment of the invention, the apparatus comprises a circuitry for aborting an operation of a system of the vehicle upon sending a short message from the cellular telephone present in the hands-free adapter. Such a circuitry may comprise:
an antenna and a receiver, for receiving radio signals sent from the cellular telephone;
a decoder, for analyzing the radio signals in order to detect a transmission of a short message.

According to one embodiment of the invention, the switching mechanism is operative while the vehicle is on (e.g., the motor of the vehicle is turned on).

According to another embodiment of the invention, the switching mechanism is operative while the vehicle is off (e.g., the motor of the vehicle is turned off).

According to one embodiment of the invention, the switching mechanism is embedded in the cellular telephone.

According to another embodiment of the invention, the switching mechanism is embedded in the hands-free adapter.

The hands-free adapter may be wired as well as wireless.

In one embodiment of the invention, the switching mechanism is adapted to turn on the vehicle only upon presence of a specific cellular telephone in said apparatus. The specific cellular telephone may be identified by a barcode reader installed in the hands-free adapter.

The switching mechanism may be implemented by elements such as a circuitry, a software module, hardware module, a computerized mechanism (i.e., code performed by CPU and memory), a combination of them, and so forth.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

FIG. 1 schematically illustrates a HFE installed in a vehicle, according to one embodiment of the invention.

FIG. 2 is a block diagram, which schematically illustrates a HFE installed in a vehicle, according to one embodiment of the invention.

FIG. 3 is a block diagram, which schematically illustrates the structure of a HFE and its connection to vehicle's systems, according to one embodiment of the invention.

FIG. 4 is a block diagram, which schematically illustrates the structure of a HFE and its connection to vehicle's systems, according to a further embodiment of the invention.

FIG. 5 is a block diagram, which schematically illustrates the structure of a HFE and its connection to vehicle's systems, according to a yet further embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. Reference numerals may be repeated among the figures in order to indicate corresponding or analogous elements.

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of clarity.

One of the major objects of a hands-free adapter is to free the user thereof from holding the handset of a cellular telephone while driving.

There are two forms of hands-free adapters: the mobile hands-free adapter, and the stationary hands-free adapter. The mobile hands-free adapter is a built-in mechanism installed in the handset of a cellular phone. The stationary hands-free adapter is an external device to a cellular phone, which is installed in a car.

A stationary hands-free adapter is usually embodied as a device which comprises a holder for the cellular telephone handset, and an audio amplifying system, for increasing the audio signal of the cellular telephone placed in the holder. It is usually installed in a position where the driver can reach the keypad, but can also view the display thereof.

The term “Hands-free Enforcer”, HFE, refers herein to an apparatus for enforcing a driver of a vehicle to use the stationary hands-free adapter installed in his vehicle.

The present invention is directed to a hands-free enforcer.

In order to enforce a driver to use the stationary hands-free adapter of his vehicle, according to embodiments of the present invention a HFE prevents igniting the vehicle thereof in the event a cellular telephone is not installed in the hands-free adapter of the vehicle.

Furthermore, while driving, if the cellular telephone is removed from the holder of a hands-free adapter, the HFE may interfere with the normal operation of one or more systems of the vehicle, such as slowing down its speed, limit its speed, activate the hazard lights of the vehicle, play an alarm sound, or even stop the vehicle's engine.

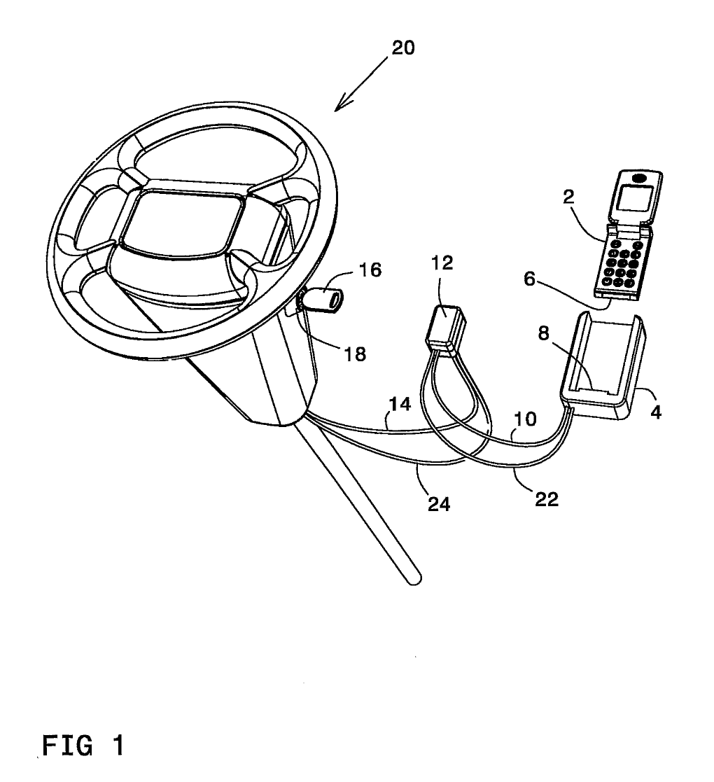

FIG. 1 schematically illustrates a HFE installed in a vehicle, according to one embodiment of the invention.

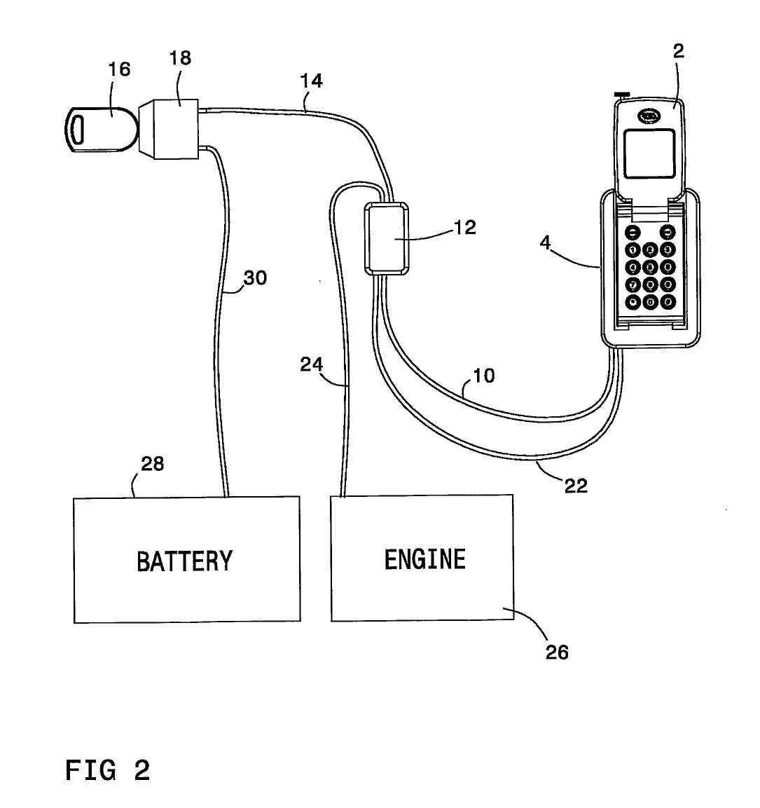

FIG. 2 is a block diagram, which schematically illustrates a HFE installed in a vehicle, according to one embodiment of the invention.

From the operational point of view, the vehicle is ignitable only when the cellular phone 2 is placed in the holder of the hands-free adapter 4. Thus, a user cannot turn on the vehicle unless his cellular telephone is placed in the holder of the hands-free adapter.

Furthermore, upon removing the cellular telephone 2 from the hands-free adapter, the vehicle's engine stops.

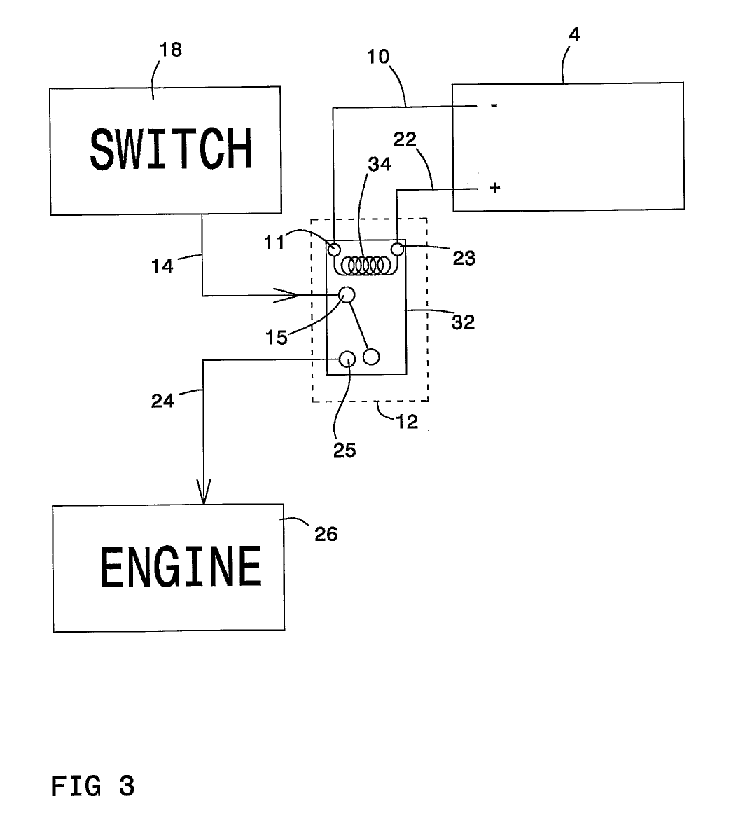

FIG. 3 is a block diagram, which schematically illustrates the structure of a HFE and its connection to vehicle's systems, according to one embodiment of the invention.

The embodiment illustrated in FIG. 3 is characterized by its simplicity.

Numeral 12 denotes a casing, which comprises circuitry of the HSE.

The term “relay” refers in the art to a device that responds to a “small” current or voltage change by activating switches or other devices in an electric circuit. Thus, the “small” current or voltage is actually a trigger.

The circuitry of the HSE comprises a relay 32, which connects/disconnects the contact between terminals 15 and 25. Terminal point 15 is connected via cable 14 to the ignition switch 18 of the vehicle, and contact 25 is connected via cable 24 to an electric system of the engine 26.

When a cellular telephone is placed in the holder of the stationary hands-free adapter 4, the power of the battery of the cellular telephone is the trigger that turns the relay to the situation wherein terminals 15 and 25 are connected. When a cellular telephone is not placed in the hands-free adapter 4, terminals 15 and 25 are not connected.

Thus, igniting the vehicle can be carried out only if a cellular telephone is placed in the holder of the stationary hands-free device of the vehicle. Furthermore, upon removing the cellular telephone from the stationary hands-free device, the vehicle stops.

Thus, a user is enforced to place his cellular telephone in the hands-free device of the vehicle while driving.

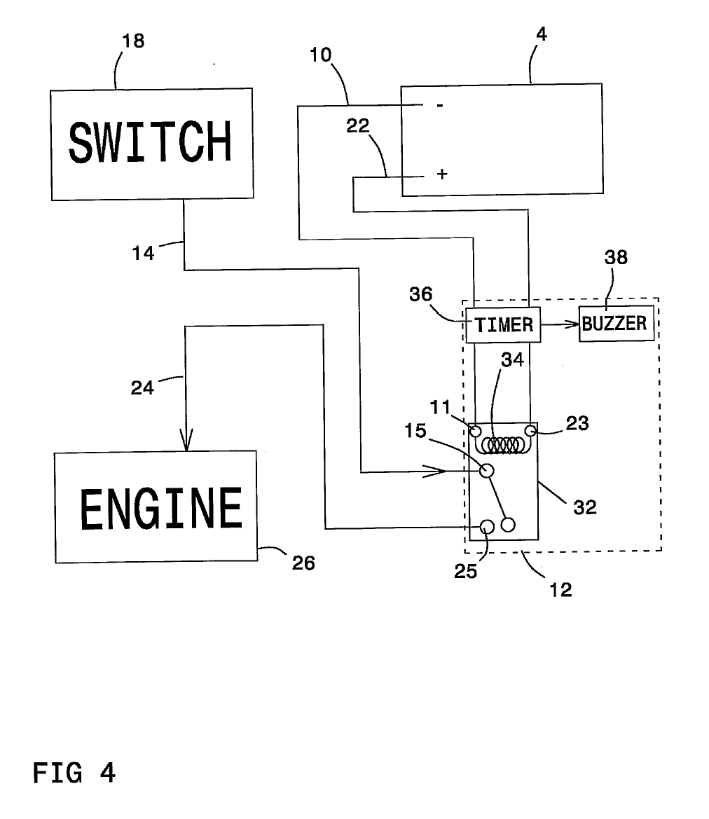

FIG. 4 is a block diagram, which schematically illustrates the structure of a HFE and its connection to vehicle's systems, according to a further embodiment of the invention.

According to this embodiment of the invention, a timer circuit 36 separates between relay 32 and the battery of the cellular telephone placed in the hands-free adapter 4. Upon removing the cellular telephone from the hands-free adapter 4, the timer retains the electric characteristics that keeps relay 32 in its current state for a “short” time period, e.g., 5 seconds. When the time period elapses, the timer stops to provide current to terminals 11 and 23, and as a result the relay disconnects the connection between terminals 15 and 25.

Thus, instead of aborting the operation of the engine of the vehicle at once, the driver is provided with a few seconds where he can regret and return the cellular telephone back to the hands-free adapter, thereby avoiding the unpleasant operation of stopping the engine his vehicle.

A buzzer 38 may be employed for playing an alert when the cellular telephone is removed from the hands-free adapter. This way the driver is provided with a warning of a few seconds before stopping his vehicle.

Since the timer requires electrical power for its operation and also for keeping the electrical characteristics, which retain relay 36 in the state where the engine continues to operate, it can be connected to the power supply of the hands-free adapter.

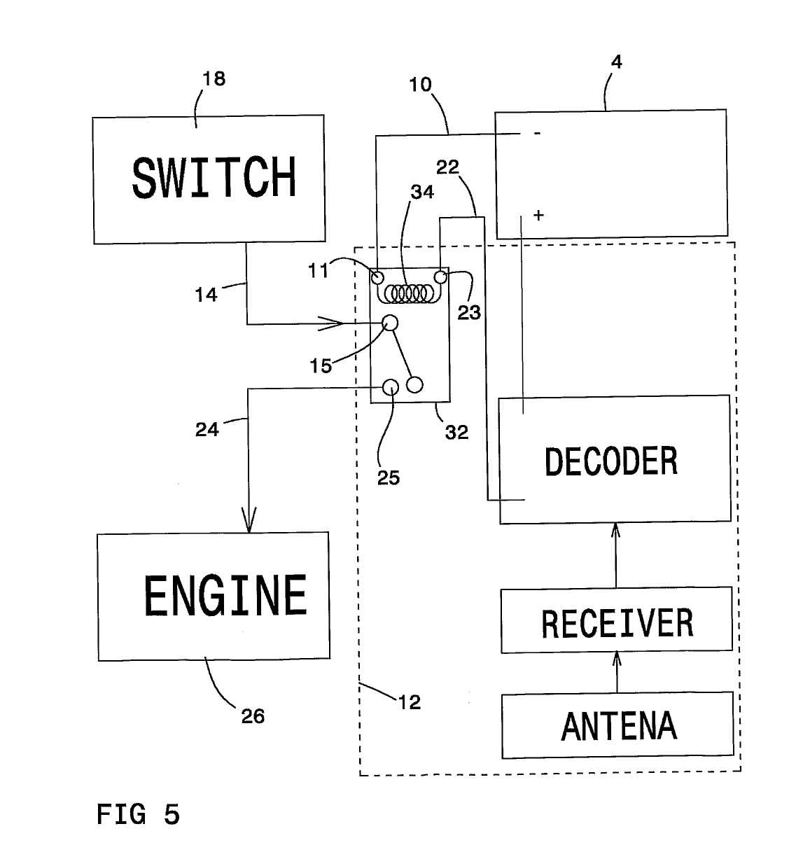

FIG. 5 is a block diagram, which schematically illustrates the structure of a HFE and its connection to vehicle's systems, according to a yet further embodiment of the invention.

According to this embodiment of the invention, the circuitry further comprises an antenna, for receiving signals transmitted by a cellular telephone, a receiver and a decoder which analyzes the transmitted signal in order to detect a transmission of a short message such as SMS. When an SMS transmission is detected, the circuitry disconnects wire 22, thereby resulting with stopping the engine of the vehicle. An SMS transmission may be detected by a code associated with an SMS message which has been sent by the cellular telephone.

The circuitry has to be adjusted to receive a transmission only from a distance of a few cm, in order to prevent analyzing radio signals from any cellular telephone, except the one placed in the hands-free device 4.

In the examples illustrated in FIGS. 1 to 5, activating the relay results with closing a circuit. According to another embodiment of the invention (not illustrated), activating the relay of the HFE results with opening (rather than closing) a circuit. Such a circuit may be the circuit that activates the hazard signal of the vehicle (or the siren). Thus, instead of stopping the engine of the vehicle, the hazard signal of the vehicle may be activated. This act is less drastic than stopping the engine of the vehicle.

It should be noted that the ignition circuit and the hazard circuit are only examples, and the operation of other circuits may be interfered additionally or alternatively, such as a circuit that controls the radio, a circuit that blinks the signaling lights, and so on.

According to one embodiment of the invention, the HSE is adapted to turn on the engine of the vehicle only upon presence of a specific cellular telephone in the apparatus. This enables using the HFE as an immobilizer of the vehicle.

According to one embodiment of the invention, the switching mechanism is operative while the vehicle is on (i.e., after the switch of the vehicle has been turned on).

According to another embodiment of the invention, the switching mechanism is operative while the vehicle is off (i.e., after the switch of the vehicle has been turned off).

According to one embodiment of the invention, the switching mechanism is embedded in the cellular telephone.

According to another embodiment of the invention, the switching mechanism is embedded in the hands-free adapter.

The hands-free adapter may be wired as well as wireless.

The communication between the cellular telephone and the hands-free adapter may be carried out by wireless communication, such as according to the Bluetooth protocol, infrared, proximity communication, and so on.

In one embodiment of the invention, the switching mechanism is adapted to turn on the vehicle only upon presence of a specific cellular telephone in said apparatus. The specific cellular telephone may be identified by a barcode reader installed in the hands-free adapter.

In the figures and description herein, the following numerals have been mentioned:
numeral 2 denotes a cellular telephone;
numeral 4 denotes a stationary hands-free adapter;
numeral 6 denotes a connector of the cellular telephone 4 with the corresponding connector of a hands-free adapter;
numeral 8 denotes a connector of the hands-free adapter 4 with the cellular telephone 2;
numeral 10 denotes a cable that connects to the negative contact point of the battery of a cellular telephone placed in the hands-free device 4;
numeral 11 denotes an input power terminal point of relay 32;
numeral 12 denotes a casing which comprises circuitry of the HSE;
numeral 14 denotes a cable that connects terminal point 15 of relay 32 to an electric system of the vehicle;
numeral 15 denotes a terminal point of a switch of relay 32;
numeral 16 denotes an ignition key;
numeral 18 denotes an electric circuit of the ignition switch of the vehicle;
numeral 20 denotes a steering wheel of the vehicle;
numeral 22 denotes a cable that connects to the positive contact point of the battery of a cellular telephone placed in the hands-free device 4;
numeral 23 denotes an input power terminal point of relay 32;
numeral 24 denotes a cable that connects terminal point 15 of relay 32 to an electric system of the vehicle;
numeral 25 denotes a terminal point of a switch of relay 32;
numeral 26 denotes an electric circuit of the engine of the vehicle;
numeral 28 denotes the battery of the vehicle;
numeral 32 denotes a relay or another switching mechanism.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A hands-free enforcing apparatus, comprising:
a hands-free adapter; and
a switching mechanism sensing presence/absence of a cellular telephone in said hands-free adapter, and affecting a circuit of the vehicle thereof according to the sensed state.

2. An apparatus according to claim 1, wherein said switching mechanism comprises a relay.

3. An apparatus according to claim 1, wherein said circuit closes upon presence of a cellular telephone in said hands-free adapter, and opened upon absence of a cellular telephone in said hands-free adapter.

4. An apparatus according to claim 1, wherein said circuit opens upon presence of a cellular telephone in said hands-free adapter, and closed upon absence of a cellular telephone in said hands-free adapter.

5. An apparatus according to claim 1, further comprising a delaying circuitry, for delaying the operation of affecting said circuit, thereby enabling a user thereof to return said cellular phone into said hands-free adapter.

6. An apparatus according to claim 4, wherein said circuit relates to a buzzer.

7. An apparatus according to claim 1, wherein said circuit relates to the ignition of said vehicle.

8. An apparatus according to claim 1, wherein said circuit relates to controlling the hazard signal of said vehicle.

9. An apparatus according to claim 1, further comprising a circuitry for aborting an operation of a system of said vehicle upon sending a short message from the cellular telephone present in said hands-free adapter.

10. An apparatus according to claim 9, wherein said circuitry for aborting an operation of a system of said vehicle upon sending a short message from the cellular telephone present in said hands-free adapter comprises:
an antenna and a receiver, for receiving radio signals sent from said cellular telephone;
a decoder, for analyzing said radio signals in order to detect a transmission of a short message.

11. An apparatus according to claim 1, wherein said switching mechanism is operative while said vehicle is on.

12. An apparatus according to claim 1, wherein said switching mechanism is operative while said vehicle is off.

13. An apparatus according to claim 1, wherein said switching mechanism is embedded in said cellular telephone.

14. An apparatus according to claim 1, wherein said switching mechanism is embedded in said hands-free adapter.

15. An apparatus according to claim 1, wherein said hands-free adapter is wireless.

16. An apparatus according to claim 1, wherein said hands-free adapter is wired.

17. An apparatus according to claim 1, wherein said switching mechanism is adapted to turn on said vehicle only upon presence of a specific cellular telephone in said apparatus.

18. An apparatus according to claim 17, wherein said specific cellular telephone is identified by a barcode reader installed in said hands-free adapter.

19. An apparatus according to claim 1, wherein said hands-free adapter communicates with said cellular telephone via wireless communication.

20. An apparatus according to claim 19, wherein said wireless communication is selected from a group comprising: RF communication, Bluetooth protocol, infrared communication, proximity communication.

21. An apparatus according to claim 1, wherein said switching mechanism comprises elements selected from a group comprising: circuitry, software, hardware, and computerized mechanism.
